(19) United States
(12) Patent Application Publication
(10) Pub. No.: US 2013/0165827 A1
(43) Pub. Date: Jun. 27, 2013

(54) BODY MASSAGE APPARATUS

(71) Applicant: Su-Ning Liu, Zhubei City (TW)

(72) Inventor: Yu-An LIU, Zhubei City (TW)

(73) Assignee: Su-Ning LIU, Zhubei City (TW)

(21) Appl. No.: 13/726,984

(22) Filed: Dec. 26, 2012

(30) Foreign Application Priority Data
Dec. 27, 2011 (CN) 201110446938.2

(51) Int. Cl. A61H 99/00

(52) U.S. Cl. CPC A61H 99/00
USPC 601/137

(57) ABSTRACT

A body massage apparatus comprises a foot plate and a bifurcated pillar having first and second outer walls and first and second inner walls. The first and second outer walls cooperatively form a first structure with an outer corner. The first and second inner walls cooperatively form a second structure with an inner corner. The first outer wall and the first inner wall extend respectively from the outer corner and the inner corner toward each other and join to form a first rounded corner. The second outer wall and the second inner wall extend respectively from the outer corner and the inner corner toward each other and join to form a second rounded corner. The second rounded corner has a radius of curvature smaller than that of the first rounded corner.

### CROSS-REFERENCE TO RELATED APPLICATION

This application claims priority of Chinese Application No. 201110446938.2, filed on Dec. 27, 2011.

### BACKGROUND OF THE INVENTION

1. Field of the Invention

This invention relates to a body massage apparatus, more particularly to a body massage apparatus including a bifurcated pillar that has outer walls and inner walls, which cooperate with the outer walls to form rounded corners with different radiuses of curvature.

2. Description of the Related Art

U.S. Patent Application Publication No. 2008/0097262 discloses a massage apparatus including a vertical post and a plurality of massage appliances secured to the vertical post for providing different types of massage treatment for different parts of a user's body. However, the vertical post and the massage appliances are separately formed, and need to be subsequently assembled together. Hence, such design results in an increase in both the manufacturing costs and the complexity of the manufacturing process.

### SUMMARY OF THE INVENTION

Therefore, an object of the present invention is to provide a body massage apparatus that can overcome the aforesaid drawbacks associated with the prior art.

According to this invention, there is a body massage apparatus that comprises: a foot plate adapted for a user to stand thereon; and a hollow bifurcated pillar of an aluminum-based extrusion secured to and extending upright from the foot plate in a vertical direction. The bifurcated pillar has top and bottom ends, first and second outer walls that extend between the top and bottom ends in the vertical direction, and first and second inner walls that extend between the top and bottom ends in the vertical direction. The first and second outer walls cooperatively form a first structure with an outer corner. The first structure has a V-shaped cross-section. The first and second inner walls cooperatively form a second structure with an inner corner. The second structure has a V-shaped cross-section. The first outer wall and the first inner wall extend respectively from the outer corner and the inner corner toward each other and join to form a first rounded corner. The second outer wall and the second inner wall extend respectively from the outer corner and the inner corner toward each other and join to form a second rounded corner. The outer corner and the first and second rounded corners are disposed in a triangular relationship, and the inner corner is disposed among the outer corner and the first and second rounded corners. The first rounded corner defines a first acute included angle and the second rounded corner defines a second acute included angle smaller than the first acute included angle. The second rounded corner has a radius of curvature smaller than that of the first rounded corner, thereby permitting the first and second rounded corners to provide different depths of penetration into the muscle of a user's body, respectively, during massage.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a body massage apparatus according to the present invention;

FIG. 2 is a fragmentary perspective view of the first preferred embodiment;

FIG. 3 is a fragmentary top schematic view of the first preferred embodiment;

FIGS. 4 and 5 are fragmentary exploded perspective views of the first preferred embodiment;

FIG. 6 is a fragmentary exploded perspective sectional view illustrating how a foot massaging plate is mounted to a foot plate of the first preferred embodiment;

FIG. 7 is a fragmentary exploded perspective view of an assembly of a bifurcated pillar, a bottle of an essential oil and a heater of the second preferred embodiment of the body massage apparatus according to the present invention;

FIG. 8 is a fragmentary perspective view of an assembly of the bifurcated pillar, a pair of elastic cords, the bottle of an essential oil and the heater of the third preferred embodiment of the body massage apparatus according to the present invention; and

FIG. 9 is a fragmentary top schematic view of the bifurcated pillar of the fourth preferred embodiment of the body massage apparatus according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

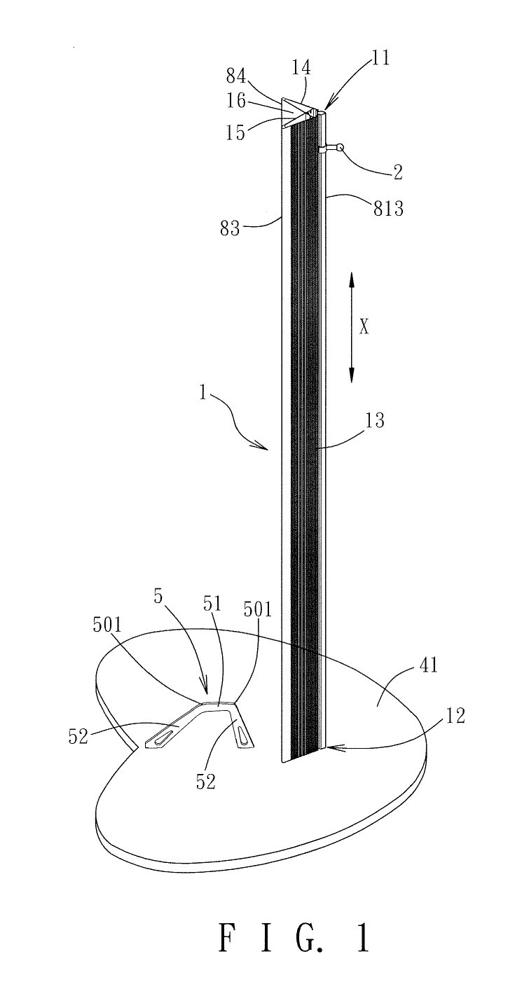

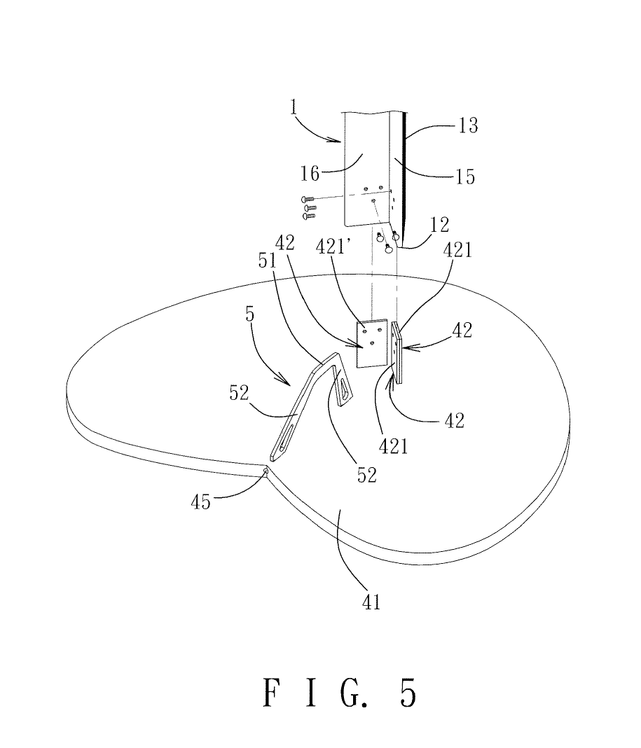

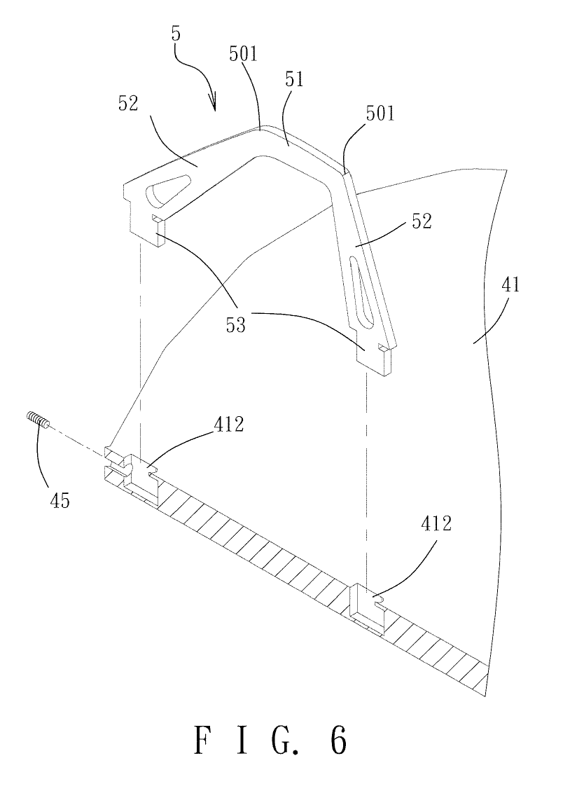

FIGS. 1 to 6 illustrate the first preferred embodiment of a body massage apparatus according to the present invention. The body massage apparatus includes: a foot plate 41 adapted for a user to stand thereon; a hollow bifurcated pillar 1 secured to and extending upright from the footplate 41 in a vertical direction (X) ; first, second and third angle bars 42; a C-shaped clamping means 21; a massaging protrusion 2; and a foot massaging plate 5.

Referring to FIGS. 1 to 3, the bifurcated pillar 1 is a single piece and is made of an aluminum-based extrusion, such as aluminum extrusion and aluminum alloy extrusion. The bifurcated pillar 1 has top and bottom ends 11, 12, first and second outer walls 13, 14 that extend between the top and bottom ends 11, 12 in the vertical direction (X), and first and second inner walls 15, 16 that extend between the top and bottom ends 11, 12 in the vertical direction (X). The first and second outer walls 13, 14 cooperatively form a vertically extending first structure 81 with a vertically extending outer corner 813. The first structure 81 has a V-shaped cross-section transverse to the vertical direction (X). The first and second inner walls 15, 16 cooperatively form a vertically extending second structure 82 with a vertically extending inner corner 823. The second structure 82 has a V-shaped cross-section transverse to the vertical direction (X). The first outer wall 13 and the first inner wall 15 extend respectively from the outer corner 813 and the inner corner 823 in respective first and second directions (L₁, L₂) toward each other, and join to form a first rounded corner 83. The second outer wall 14 and the second inner wall 16 extend respectively from the outer corner 813 and the inner corner 823 in respective third and fourth directions (L₃, L₄) toward each other, and join to form a second rounded corner 84. The first inner wall 15 cooperates with the first outer wall 13 to define a first gap 17 therebetween. The second inner wall 16 cooperates with the second outer wall 14 to define a second gap 18 therebetween. Each of the first and second outer walls 13, 14 is corrugated so as to enhance the mechanical strength of the bifurcated pillar 1 and to provide an additional massaging treatment for the user.

The outer corner 813 and the first and second rounded corners 83, 84 are disposed in a triangular relationship. The inner corner 823 is disposed between the first and second outer walls 13, 14 and among the outer corner 813 and the first and second rounded corners 83, 84. The first rounded corner 83 defines a first acute included angle (α). In this embodiment, the first and second directions (L₁, L₂) are transverse to the vertical direction (X), and intersect to form the first acute included angle (α) therebetween. The second rounded corner 84 defines a second acute included angle (β) smaller than the first acute included angle (α). In this embodiment, the third and fourth directions (L₃, L₄) are transverse to the vertical direction (X), and intersect to form the second acute included angle (β). The second rounded corner 84 has a radius (r′) of curvature smaller than that (r) of the first rounded corner 83, thereby permitting the first and second rounded corners 83, 84 to provide different depths of penetration into the muscle of a user's body, respectively, during massage.

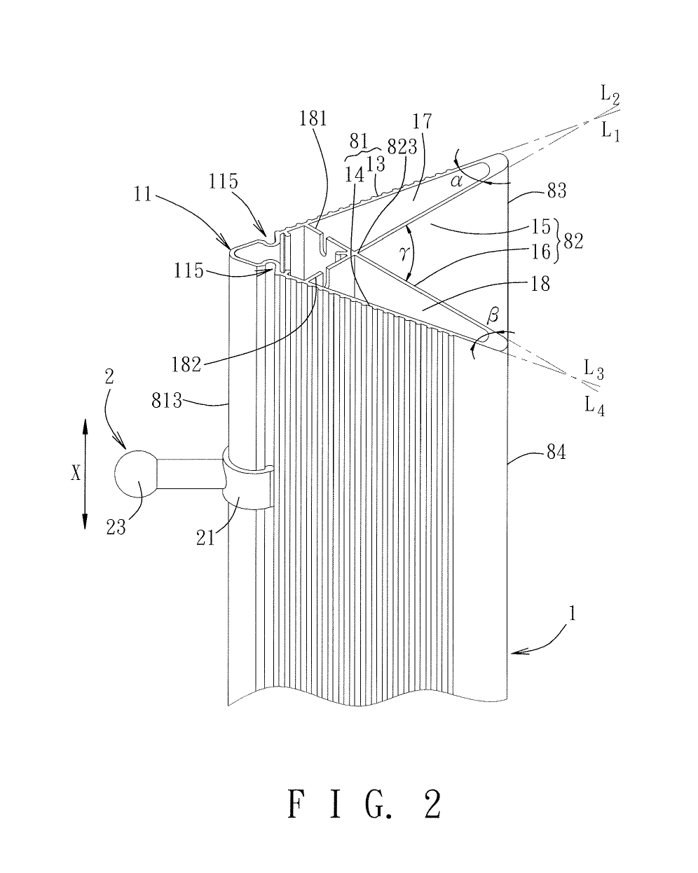

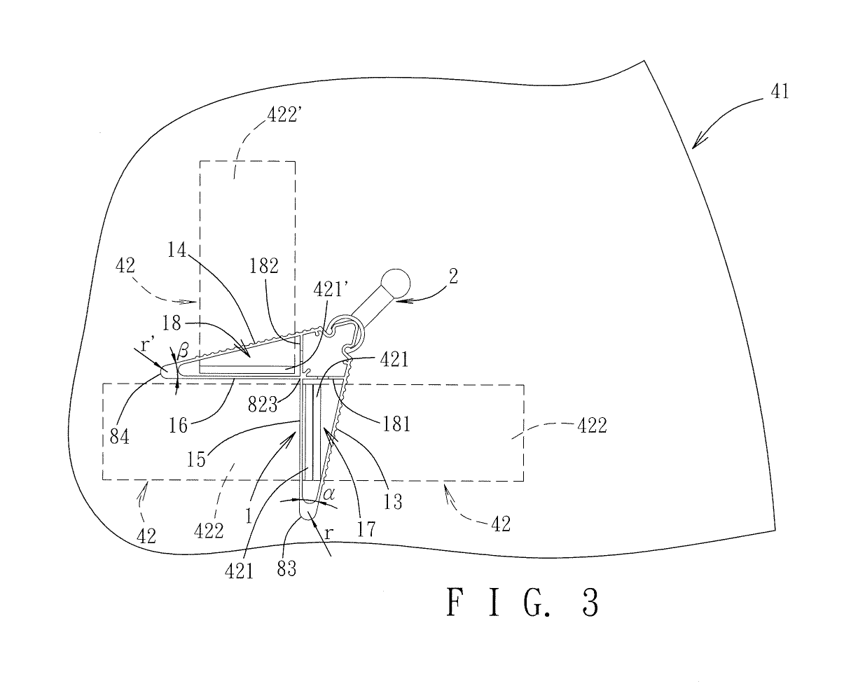

Referring to FIGS. 3 to 5, the foot plate 41 is formed with two first slits 411 and two second slits 412, and each of the first and second angle bars 42 has first and second segments 421, 422 that are transverse to each other. The third angle bar 42 has first and second segments 421′, 422′ that are transverse to each other. The first segments 421 of the first and second angle bars 42 are attached to each other, extend through a respective one of the first slits 411 in the foot plate 41 and into the first gap 17, and are fastened to the first inner wall 15. The second segments 422 of the first and second angle bars 42 extend respectively from the first segments 421 of the first and second angle bars 42 in respective opposite directions, and are fastened to the foot plate 41. The first segment 421′ of the third angle bar 42 extends through the other of the first slits 411 in the foot plate 41 and into the second gap 18, and is fastened to the second inner wall 16. The second segment 422′ of the third angle bar 42 extends from the first segment 421′ of the third angle bar 42 in a direction transverse to the second segments 422 of the first and second angle bars 42, and is fastened to the footplate 41. With further reference to FIG. 2, the second direction (L₂) and the fourth direction (L₄) preferably form an included angle (γ) ranging from 90 degrees to 135 degrees. More preferably, the included angle (γ) is substantially 90 degrees. As such, when an external force is applied to an upper position of the bifurcated pillar 1 during massage to generate a considerably large torque acted on the bottom end 12 of the bifurcated pillar 1 and the foot plate 41, the torque can be evenly distributed on the bottom end 12 of the bifurcated pillar 1 and the foot plate 41 through the arrangement of the first, second and third angle bars 42 in their relative positions.

The massaging protrusion 2 extends from the C-shaped clamping means 21 in a direction transverse to the vertical direction (X), and has a ball-shaped free end 23. Each of the first and second outer walls 13, 14 is formed with a guiding groove 115 extending in the vertical direction (X) along the length of the bifurcated pillar 1. The C-shaped clamping means 21 extends into the guiding groves 115 in the first and second outer walls 13, 14 to clamp the first and second outer walls 13, 14, and is adjustable in position along the length of the bifurcated pillar 1.

The bifurcated pillar 1 further includes first and second reinforcing walls 181, 182 (see FIG. 2). The first reinforcing wall 181 extends from the inner corner 823 to the first outer wall 13 in the fourth direction (L₄), and the second reinforcing wall 182 extends from the inner corner 823 to the second outer wall 14 in the second direction (L₂) so as to enhance the mechanical strength of the first and second inner walls 15, 16.

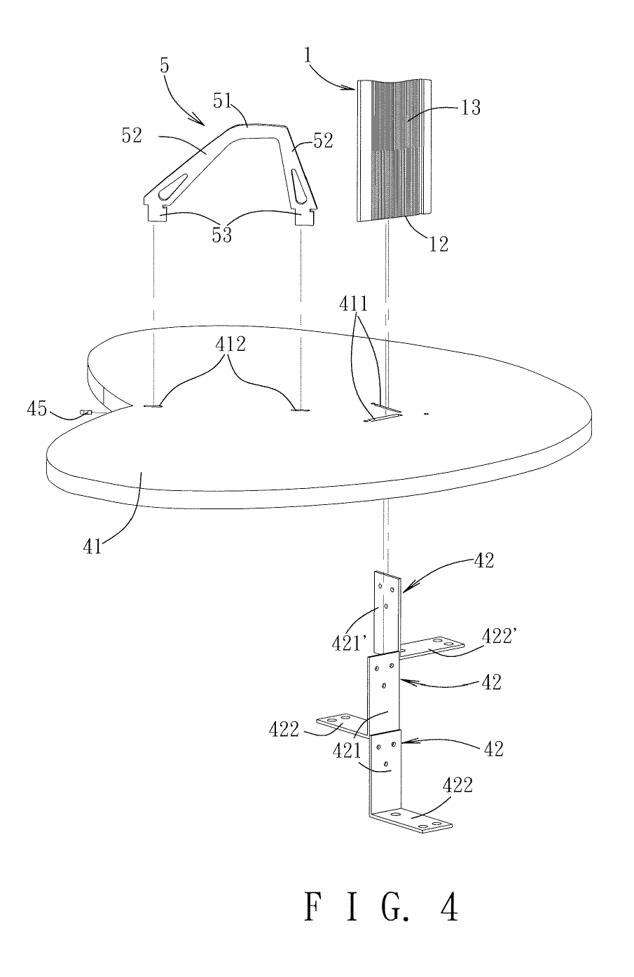

Referring to FIGS. 4 to 6, the foot massaging plate 5 protrudes upwardly from the foot plate 41, and has a top segment 51, two leg segments 52 extending downwardly and inclinedly from the top segment 51 to the foot plate 41 and cooperating with the top segment 51 to define two obtuse corners 501 for massaging treatment, and two engaging segments 53 extending downwardly and respectively from the leg segments 52 and engaging respectively in the second slits 412 in the foot plate 41. A fixing pin 45 extends into the foot plate 41 to abut against one of the wedging segments 53 for securing the foot massaging plate 5.

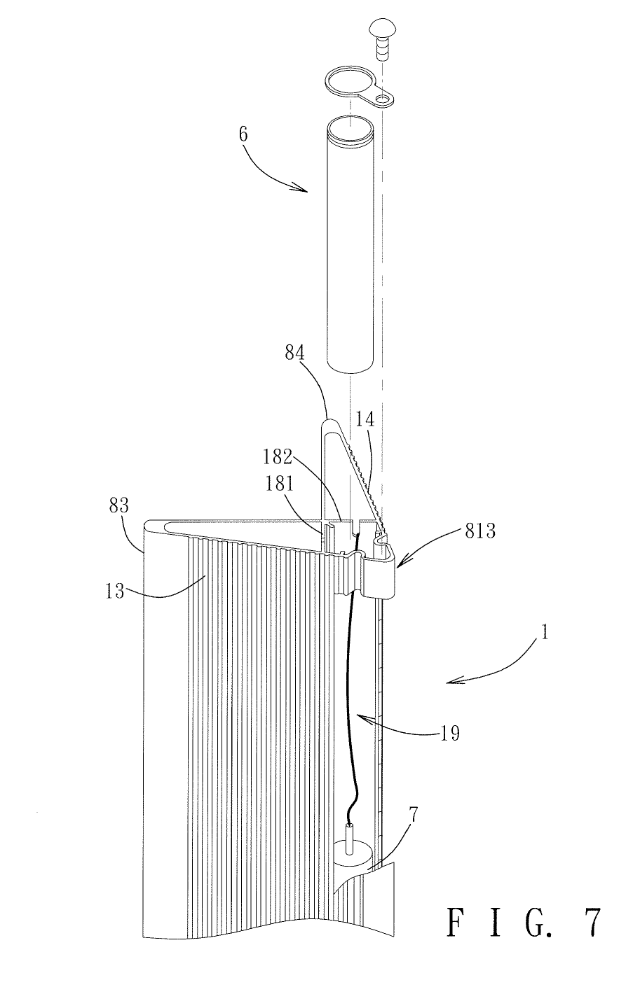

FIG. 7 illustrates the second preferred embodiment of the body massage apparatus according to the present invention. The second preferred embodiment differs from the previous embodiment in that the second preferred embodiment further includes a bottle 6 of an essential oil (not shown) and an electric heater 7 for heating the essential oil to release the essential oil in vapor form. The first and second outer walls 13, 14 and the first and second reinforcing walls 181, 182 cooperatively define an accommodation space 19 there among. The bottle 6 and the electric heater 7 are mounted in the accommodation space 19.

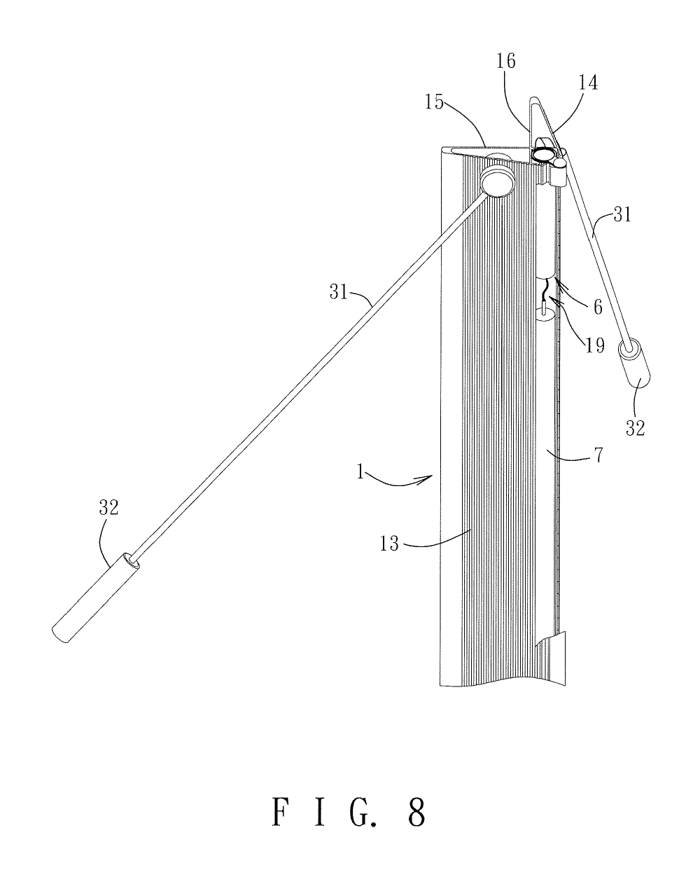

FIG. 8 illustrates the third preferred embodiment of the body massage apparatus according to the present invention. The third preferred embodiment differs from the second preferred embodiment in that the third preferred embodiment further includes first and second elastic cords 31 mounted respectively on the first and second outer walls 13, 14 and provided respectively with handgrips 32 for muscular exercising.

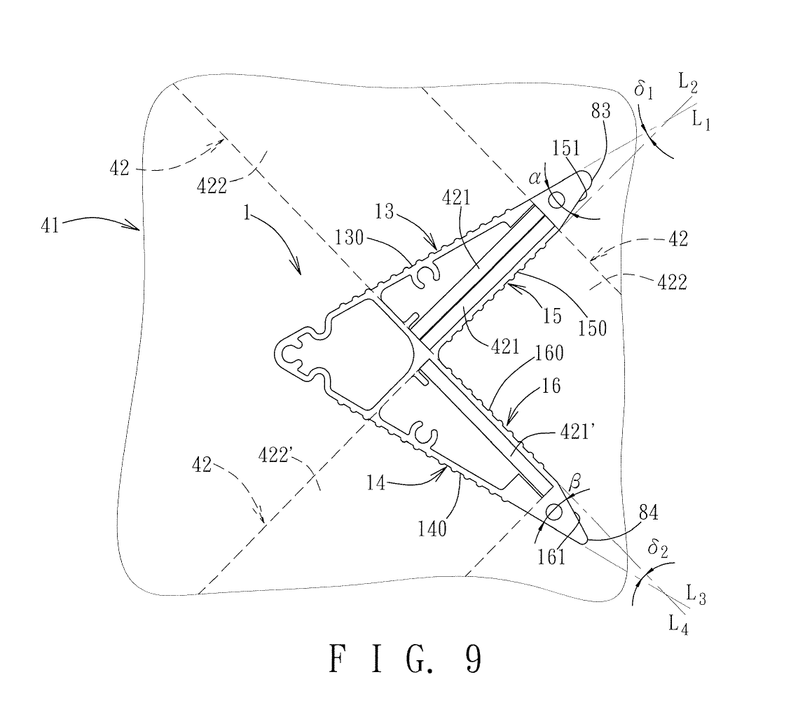

FIG. 9 illustrates the fourth preferred embodiment of the body massage apparatus according to the present invention. The fourth preferred embodiment differs from the first preferred embodiment in that the first inner wall 15 of the fourth preferred embodiment has a main portion 150 extending in the second direction (L₂) and an end portion 151 extending in a direction slightly deviating from the second direction (L₂), that the second inner wall 16 of the fourth preferred embodiment has a main portion 160 extending in the fourth direction (L₄) and an end portion 161 extending in a direction slightly deviating from the fourth direction (L₄), that the first and second directions (L₁, L₂) intersect to form an angle (δ₁) smaller than the first acute included angle (α) defined by the first rounded corner 83, and that the third and fourth directions (L₃, L₄) intersect to form an angle (δ₂) smaller than the second acute included angle (β) defined by the second rounded corner 84.

By the arrangement of the first and second outer walls 13, 14 and the first and second inner walls 15, 16 of the bifurcated pillar 1, i.e., by making the first outer wall 13 and the first inner wall 15 approach each other, making the second outer wall 14 and the second inner wall 16 approach each other and by disposing the inner corner 823 between the first and second outer walls 13, 14, the first and second rounded corners 83, 84 with different radiuses of curvature, which serve to provide massaging functions with different depths of penetration into the muscle of a user's body during massage, can be easily formed on the bifurcated pillar 1 through aluminum-based extrusion techniques, thereby eliminating the aforesaid drawbacks associated with the prior art.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A body massage apparatus comprising:
a foot plate adapted for a user to stand thereon; and
a hollow bifurcated pillar of an aluminum-based extrusion secured to and extending upright from said foot plate in a vertical direction, said bifurcated pillar having top and bottom ends, first and second outer walls that extend between said top and bottom ends in said vertical direction, and first and second inner walls that extend between said top and bottom ends in said vertical direction, said first and second outer walls cooperatively forming a first structure with an outer corner, said first structure having a V-shaped cross-section, said first and second inner walls cooperatively forming a second structure with an inner corner, said second structure having a V-shaped cross-section, said first outer wall and said first inner wall extending respectively from said outer corner and said inner corner toward each other and joining to form a first rounded corner, said second outer wall and said second inner wall extending respectively from said outer corner and said inner corner toward each other and joining to form a second rounded corner;
wherein said outer corner and said first and second rounded corners are disposed in a triangular relationship, and said inner corner is disposed among said outer corner and said first and second rounded corners;
wherein said first rounded corner defines a first acute included angle and said second rounded corner defines a second acute included angle smaller than said first acute included angle; and
wherein said second rounded corner has a radius of curvature smaller than that of said first rounded corner, thereby permitting said first and second rounded corners to provide different depths of penetration into the muscle of a user's body, respectively, during massage.

2. The body massage apparatus of claim 1, wherein said first outer wall and said first inner wall extend respectively from said outer corner and said inner corner in respective first and second directions toward each other, said second outer wall and said second inner wall extending respectively from said outer corner and said inner corner in respective third and fourth directions toward each other, said first, second, third and fourth directions being transverse to said vertical direction.

3. The body massage apparatus of claim 2, wherein said second direction and said fourth direction form an included angle ranging substantially from 90 degrees to 135 degrees.

4. The body massage apparatus of claim 1, further comprising first, second and third angle bars, said foot plate being formed with two slits, each of said first, second and third angle bars having first and second segments that are transverse to each other, said first inner wall cooperating with said first outer wall to define a first gap therebetween, said second inner wall cooperating with said second outer wall to define a second gap therebetween, said first segments of said first and second angle bars being attached to each other, extending through one of said slits in said foot plate and into said first gap and being fastened to said first inner wall, said second segments of said first and second angle bars extending respectively from said first segments of said first and second angle bars in respective opposite directions and being fastened to said foot plate, said first segment of said third angle bar extending through the other of said slits in said foot plate and into said second gap and being fastened to said second inner wall, said second segment of said third angle bar extending from said first segment of said third angle bar in a direction transverse to said second segments of said first and second angle bars and being fastened to said foot plate.

5. The body massage apparatus of claim 1, further comprising a C-shaped clamping means and a massaging protrusion extending from said C-shaped clamping means in a direction transverse to said vertical direction, each of said first and second outer walls being formed with a guiding groove extending along the length of said bifurcated pillar, said C-shaped clamping means extending into said guiding groves in said first and second outer walls to clamp said first and second outer walls and being adjustable in position along the length of said bifurcated pillar.

6. The body massage apparatus of claim 1, wherein each of said first and second outer walls and said first and second inner walls is corrugated.

7. The body massage apparatus of claim 2, further comprising first and second reinforcing walls, said first reinforcing wall extending from said inner corner to said first outer wall in said fourth direction, said second reinforcing wall extending from said inner corner to said second outer wall in said second direction.

8. The body massage apparatus of claim 7, further comprising a bottle for containing an essential oil and a heater for heating the essential oil, said first and second outer walls and said first and second reinforcing walls cooperatively defining an accommodation space there among, said bottle and said heater being mounted in said accommodation space.

9. The body massage apparatus of claim 1, further comprising a foot massaging plate protruding upwardly from said foot plate and having a top segment, two leg segments extending downwardly and inclinedly from said top segment to said foot plate and cooperating with said top segment to define two obtuse corners for massaging treatment, and two engaging segments extending downwardly and respectively from said leg segments and engaging said foot plate.

10. The body massage apparatus of claim 1, further comprising first and second elastic cords mounted on said first and second outer walls, respectively, for muscular exercising.
